(19) United States
(12) Patent Application Publication
(10) Pub. No.: US 2016/0052528 A1
(43) Pub. Date: Feb. 25, 2016

(54) DEVICE FOR CONVEYING MATERIAL DURING TRACK LAYING

(71) Applicant: SYSTEM7-RAILSUPPORT GMBH, Wien (AT)

(72) Inventor: Bernhard Lichtberger, Pregarten (AT)

(21) Appl. No.: 14/784,150

(22) PCT Filed: Feb. 25, 2014
(86) PCT No.: PCT/EP2014/053612

§ 371 Date: Oct. 13, 2015

(30) Foreign Application Priority Data
Apr. 12, 2013 (EP) 13163512.0

(51) Int. Cl. B61D 47/00; B65G 15/00; B65G 67/02; B61D 3/16

(52) U.S. Cl. CPC B61D 47/00; B61D 3/16; B65G 15/00; B65G 67/02

(57) ABSTRACT

A device, proposed for conveying material during track laying, includes material-conveying silo units which can be moved on a track and receive material between side walls which define the silo chamber on a bottom conveyor belt for conveying the material along the bottom. A material-conveying silo includes a plurality of material silo units which are coupled to one another and, in the region of their end faces which face one another, include devices for transferring the material from one material-conveying silo unit to the next material-conveying silo unit. In order to increase the useful volume of the material-conveying silo, the material-conveying silo is of articulated configuration, where the frames of two material-conveying silo units which adjoin one another are supported in an articulated manner on a common running gear, and the silo chamber is of continuous configuration.

### FIELD OF THE INVENTION

The invention relates to a device for conveying material during track laying, comprising material-conveying silo units which can be moved on a track and receive material between side walls which define the silo chamber on a bottom conveyor belt for conveying the material along the bottom, wherein a material-conveying silo comprises a plurality of material silo units which are coupled to one another and, in the region of their end faces which face one another, comprise devices for transferring the material from one silo unit to the next silo unit.

### DESCRIPTION OF THE PRIOR ART

Material-conveying silo units for loading, supplying and conveying track-laying material such as ballast, excavated material or subgrade protection layer material etc are used in track laying and track maintenance. The material-conveying silo units are used in construction and reconditioning measures for railway tracks. They convey and store either new materials such as ballast or subgrade protection layer material, or general-utility materials such as excavated material which is obtained during ballast cleaning work or cleaned ballast. They are also used as an intermediate storage unit in ballast distribution machines or the like.

Known material-conveying silo units comprise silo wagons which receive track-laying material between side walls, which define the silo chamber, on a bottom conveyor belt for conveying the material along the bottom. The material-conveying silo unit comprises several wagons which are equipped with a device transferring the material from one wagon to the next wagon in the region of their mutually facing face ends (DE 10 2009 037 568 B3). For this purpose, the two face ends of each wagon can be pivoted downwardly and a respective conveyor belt for transferring the material from one wagon to the adjoining wagon is provided on or in the two face ends. According to another embodiment, the wagon can comprise at its two head-ends a respective bottom transfer conveyor belt in the region of the bottom conveyor belt, which bottom transfer conveyor belt can be triggered and actuated in such a way that commencing from a horizontal starting position it can be pivoted or bent into an ejection position for transferring the material to the adjoining wagon.

The material-conveying silo units are coupled via push-pull apparatuses which are known from railways and in numerous configurations. There are smaller material-conveying silo units with two double-axle pivoted bogeys, slightly larger ones with two double pivoted bogeys (with four axles each). The vehicles can be obtained as self-propelled vehicles or can be coupled conventionally to a railcar. Configurations are also known which are additionally able to travel on caterpillars, i.e. in a trackless manner.

Since the bottom conveyor belts respectively need to convey materials to the transfer conveyor belt of the next material-conveying silo unit in the prior art, the silos are attached in a slightly longitudinally inclined or elevated manner in the longitudinal direction of the track in order to ensure clean material transfer from one conveyor belt to the next. As a result of said longitudinal inclination, the transfer conveyor belt fits beneath the bottom conveyor belt. The disadvantages of this configuration are the unused space beneath the oblique inclination or elevation and the required increased drive force for the conveyor belt, which is necessary in order to convey the conveying material up the inclination. It is also disadvantageous in the current configurations that a relatively large empty space is produced in the region of the transfer conveyor belt between the individual coupled material-conveying silo units. This leads to relatively high dead weights and reduced loading volumes that can be used. This means simultaneously that a relatively large number of axles are required per useful loading weight. The maximum axle load is currently limited in Europe at 22.5 t. The weight per metre with which the track may be loaded is also limited by respective regulations. If the trains composed of the material-conveying silo units are to be used on existing tracks which due to the configuration of the upper structure and the bridges only allow lower axle loads and specific axle sequences, there are considerable restrictions in the utilisation of such trains. The double pivoted bogeys, which are usually used in the most frequently used material-conveying silo units, are relatively complex and expensive in their configuration. As a result of the limits which are imposed by the clearance gauge to the top and the side and depend on the respective countries, the area of use of the silos is highly limited with respect to space. Short wagon lengths additionally reduce the useful loading weight per material-conveying silo unit.

### SUMMARY OF THE INVENTION

The invention is thus based on the object of providing a device of the kind mentioned above which avoids the aforementioned disadvantages, i.e. especially offers an increased useful volume per material-conveying silo unit, is arranged in the simplest possible way and provides a high useful loading weight per material-conveying silo unit even in the case of short lengths of each material-conveying silo unit.

This object is achieved in accordance with the invention in such a way that the material-conveying silo unit is of articulated configuration, wherein the frames of two material-conveying silo units which adjoin one another are supported in an articulated manner on a common running gear, and the silo chamber is of continuous configuration, in particular with an at least approximately identical silo chamber cross-section over the material-conveying silo length.

The relevant aspect of the invention is the composition of the material-conveying silo from material-conveying silo units which are coupled in articulated configuration. In this respect, any number of individual material-conveying silo units can principally be connected to each other. The individual material-conveying silo units are connected to each other in an articulated manner, as a result of which an at least approximately identical silo chamber cross-section is provided over the length of the material-conveying silo unit and maximum useful volume is available for each material-conveying silo unit. As a result and since the frames of two mutually adjoining material-conveying silo units are supported in an articulated manner on a common running gear, a high useful loading weight (loading volume) per material-conveying silo unit is available even in the case of short lengths of each material-conveying silo unit. The length of the material-conveying silo units is obtained from the boundary conditions such as maximum wheel loads, wheel load sequences, clearance gauge profile and curve radii.

The pivot joint is situated directly above the running gear, e.g. a pivoted bogey. The open region between the conveyor belts at the same height (with the exception of the transfer part) is bridged via a rotary disc or a transfer plate. Longitudinal inclination and rotation compensation skirts are especially provided in the bottom region above the running gear and between the bottom conveyor belts of two adjoining material-conveying silo units. As a result of the force exerted by the conveyor belts on the heaped material, the material slides via the rotary disc or longitudinal inclination and rotation compensation skirts, which can also be equipped with a vibration drive so that the transport thereon can occur more easily. It is recommended to produce the longitudinal inclination and rotation compensation skirts from abrasion-proof and highly slidable material such as carbon-fibre-reinforced plastic.

It is recommended for this purpose if the longitudinal inclination and rotation compensation skirts are associated with an actuating drive, with which they can be lifted during unloading from a horizontal working position to an upright unloading position in order to supply the residual material still resting on the longitudinal inclination and rotation compensation skirts after unloading to the discharging bottom conveyor belt. The longitudinal inclination and rotation compensation skirts are thus formed in such a way that they can be lifted during unloading in order to also supply the residual material that is still resting thereon after unloading to the removing conveyor belt. In addition and alternatively, the longitudinal inclination and rotation compensation skirts can be formed as a vibrating conveyor, with which vibrating conveyors it is possible to supply material resting on the longitudinal inclination and rotation compensation skirts to a removing bottom conveyor belt. The longitudinal inclination and rotation compensation skirts move obliquely to the top in the transport direction and back again, wherein the conveyed material is lifted depending on the ejection ratio for conveying and is thrown in the intended direction. During the return stroke, the conveyed material remains static due to mass inertia. Said vibration conveyor drive is primarily used to remove residual material still resting on the longitudinal inclination and rotation compensation skirts.

In order to ensure that the material-conveying silo units are unable to twist against each other, the frames of two mutually adjoining material-conveying silo units resting on a common running gear are equipped with a twist blocking unit which prevents a free mutual torsional movement of the two frame parts around the longitudinal axis of the device. Such a twist blocking unit can be realised in an especially simple and advantageous manner if the twist blocking unit comprises at least one frame protrusion protruding from a frame flank in the longitudinal direction of the device against the frame of the adjoining material-conveying silo unit, which frame protrusion engages in a respective diametrically opposed guide receiver.

For example, frame protrusions protrude from the frame to the left and the right of the running gear, which protrusions are guided in the respective fork elements on adjoining frames. Rollers which are cambered laterally, at the top and bottom of the frame protrusions are mounted in the fork elements for guiding the frame protrusions for example. The tolerances are dimensioned in such a way that the necessary horizontal and vertical rotations of the coupled material-conveying silo units are possible without tensions, but that free movement around the longitudinal axis of the material-conveying silo is prevented. The safety against derailment is ensured by the suspensions of the running gears and the plays in the support of the wagon parts on the running gear.

In order to advantageously close the silo with respect to side walls in the region of the pivot joints between adjoining material-conveying silo units, it is proposed that longitudinal compensation plates are associated with the side walls, which plates protrude at the face end against the adjoining material-conveying silo unit and are movably arranged on the side walls, wherein the mutually associated longitudinal compensation plates and optionally side walls of mutually adjoining material-conveying silo units overlap in the longitudinal direction of the device. For example, mutually associated longitudinal compensation plates can be mounted in an articulated manner at one end to a side wall in the longitudinal direction of the device and can be formed in a displaceable manner at the other end along the side wall of the adjoining material-conveying silo unit. The longitudinal inclination and rotation compensation skirts and/or the longitudinal compensation plates preferably consist of especially wear-resistant material of low coefficient of friction, i.e. carbon fibre composite material, hard-coated steel sheet or Hardox sheet metal.

The running gear can comprise individual axles, double-axle or triple-axle pivoted bogeys or double bogeys. Furthermore, the running gear comprises a stop on the upper side for mutually protruding coupling lugs which protrude from the frames of two mutually adjoining material-conveying silo units, wherein especially one of the two coupling lugs encloses the other one in the manner of a fork and both coupling lugs act jointly on the stop. Such a configuration of the connection allows free horizontal and vertical twisting of the two frame parts with respect to each other, as a result of which the combination of the material-conveying silo units can adjust to curves and changes in inclination.

In contrast to the prior art, which provides a diesel unit, a generator and a hydraulic system for each wagon, the device in accordance with the invention preferably only comprises a diesel engine, a power generator and a control unit for supplying and triggering the hydraulic systems of all material-conveying silo units.

The material-conveying silo can both be arranged with running axles and also as a self-propelled unit. It is also possible to additionally form the material-coming silo as a vehicle that travels in a trackless manner, for which purpose additionally attached caterpillars can be provided beneath frame.

### BRIEF DESCRIPTION OF THE DRAWINGS

The subject matter of the invention is shown by way of example in the drawings, wherein:

FIG. 1 shows a material-conveying silo in accordance with the invention in a partly sectional side view;

FIG. 2 shows an enlarged sectional view of FIG. 1 in the region of a running axle;

FIG. 3 shows a top view of two mutually adjoining material-conveying silo unit frames in the coupling region;

FIG. 4 shows the guide of FIG. 3 in a sectional view along the line IV-IV and on an enlarged scale;

FIG. 5 shows the enlarged coupling of FIG. 3 in a side view;

FIG. 6 shows the enlarged coupling of FIG. 3 in a top view;

FIG. 7 shows the coupling of FIG. 5 in a sectional view along the line VII-VII and

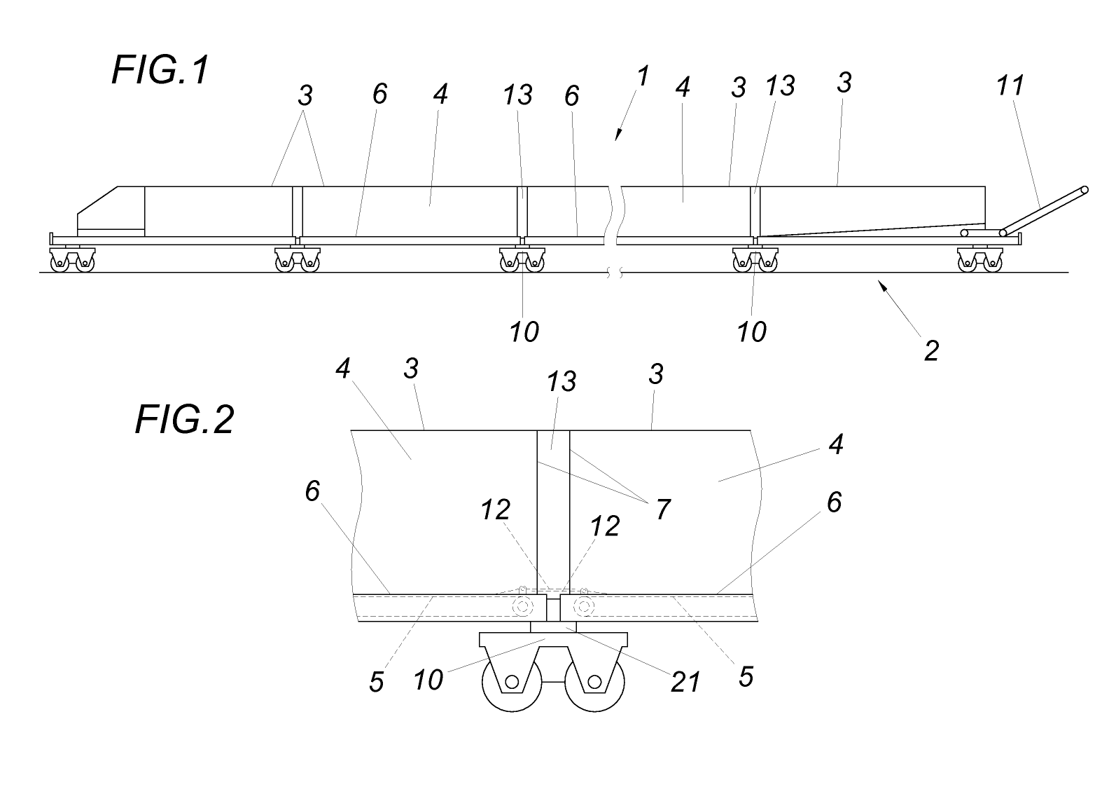

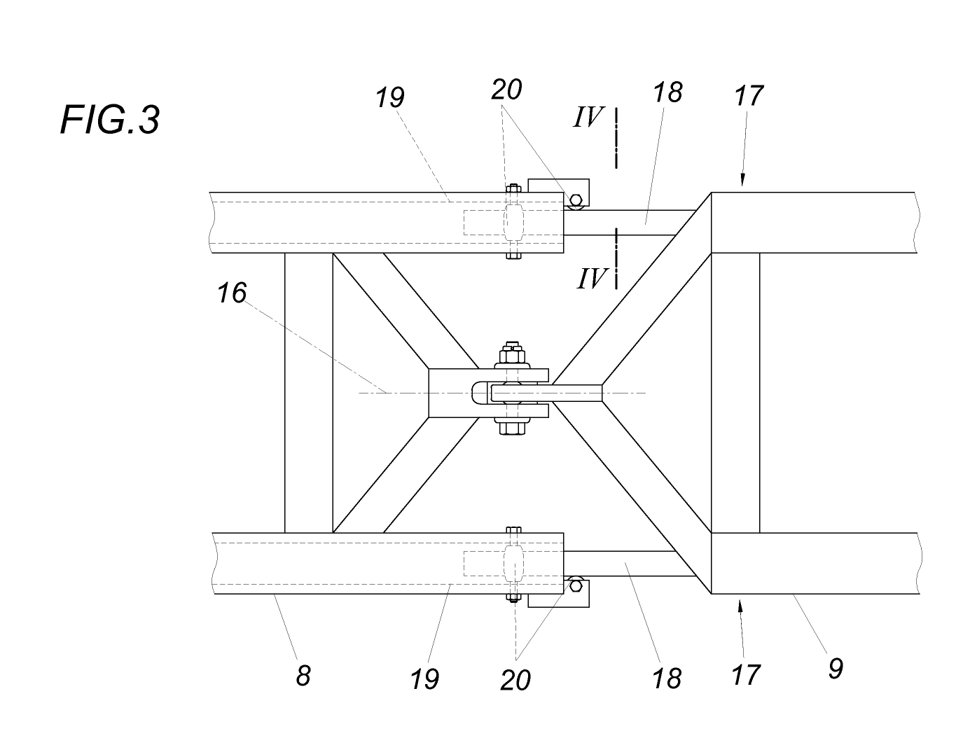

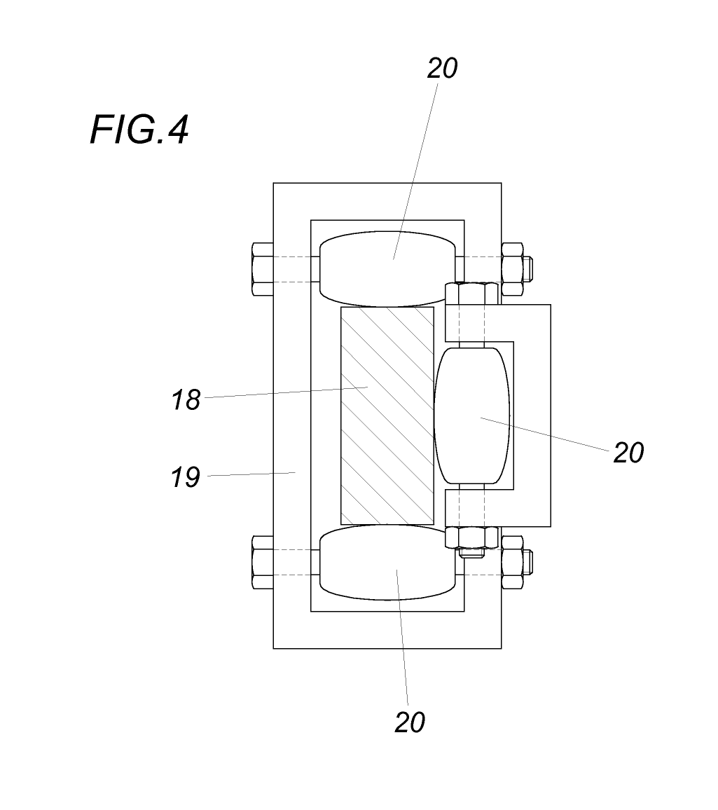

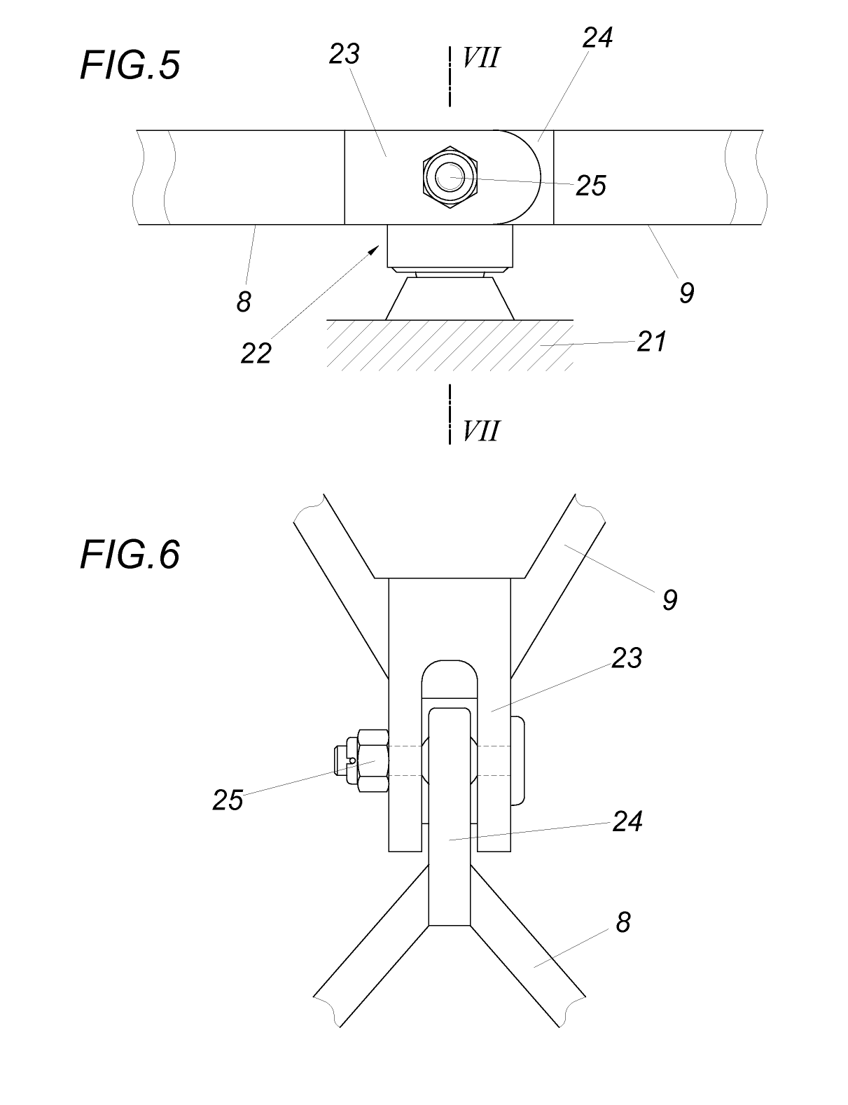

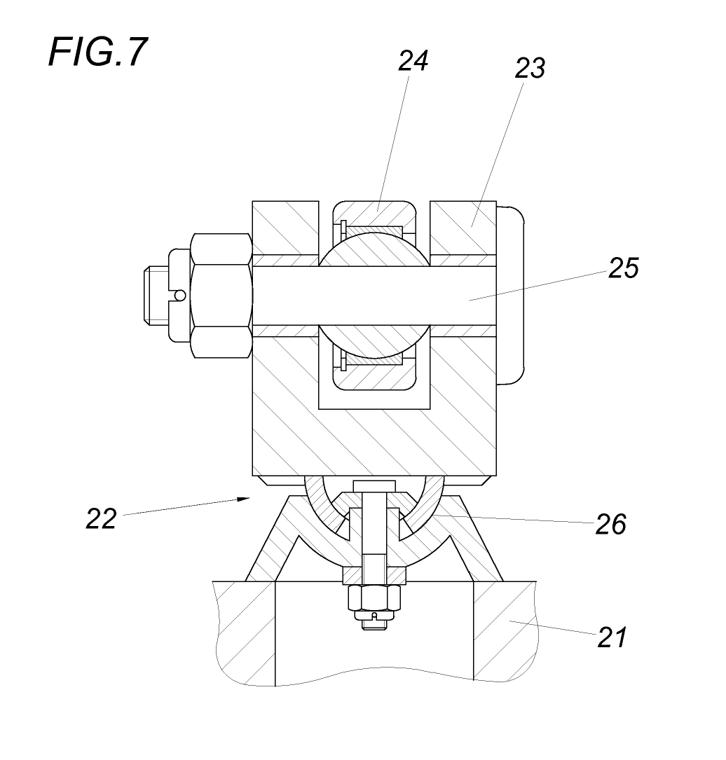

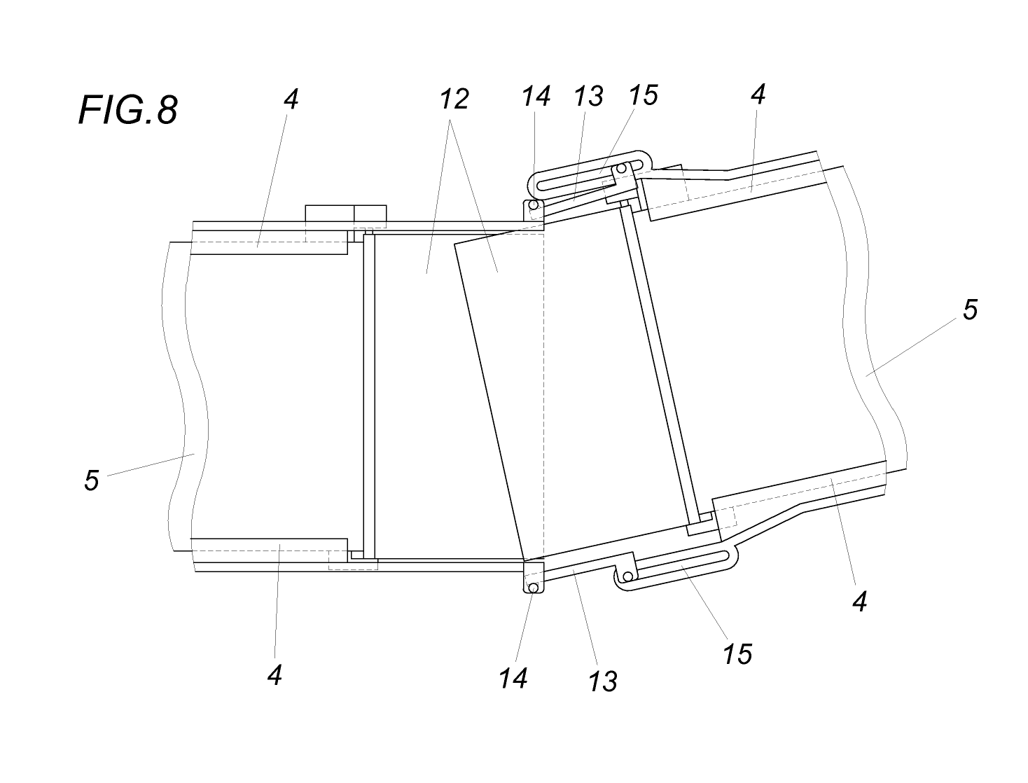

### DESCRIPTION OF THE PREFERRED EMBODIMENT

The illustrated device for conveying material in tracklaying, i.e. a material-conveying silo 1, comprises material-conveying silo units 3 which can be moved on a track 2 and which receive material between side walls 4 defining the silo chamber on a bottom conveyor belt 5 for conveying the material along the bottom 6, wherein a material-conveying silo 1 comprises several material-conveying silo units 3 which are coupled to each other and which, in the region of their mutually facing face ends 7, comprise devices for transferring the material from a material-conveying silo unit 3 to the next material-conveying silo unit 3.

The material-conveying silo 1 is arranged in articulated configuration for the purpose of utilising in the best possible way the theoretically available total silo volume, wherein the frames 8, 9 of two mutually adjoining material-conveying silo units 3 rest in an articulated manner on a common running gear 10 and the silo chamber is continuously arranged, especially with a silo chamber cross-section which is at least approximately constant over the length of the material-conveying silo unit. Conventional transfer devices 11 are merely provided at the tip and the end of the train in order to enable the use of the train with existing systems.

Longitudinal inclination and rotation compensation skirts 12 are provided in the bottom region above the running gear 10 and between the bottom conveyor belts 5 of two mutually adjoining material-conveying silo units 3, via which the material is pushed during operation of the bottom conveyor belt 5. An actuating drive is associated with the longitudinal inclination and rotation compensation skirts 12, with which they can be lifted during unloading from a horizontal working position to an upright unloading position in order to supply the residual material still resting after unloading on the longitudinal inclination and rotation compensation skirts 12 to the removing bottom conveyor belt 5.

For the purpose of sealing the side walls 4 in the region between the material-conveying silo units 3 above the pivoted bogeys, the side walls 4 are associated with longitudinal compensation plates 13 which protrude at the face end against the adjoining material-conveying silo unit 3 and which are movably arranged on the side walls 4, wherein the mutually associated longitudinal competition plates 13 and optionally the side walls 4 of mutually adjoining material-conveying silo units 3 overlap in the longitudinal direction of the device. The mutually associated longitudinal compensation plates 13 are mounted in an articulated manner on a side wall 4 in bearings 14 in the longitudinal direction of the device at the one end and are displaceably guided at the other end in a guide 15 along the side wall 4 of the adjoining material-conveying silo unit 3.

Furthermore, the frames 8, 9 of two mutually adjoining material-conveying silo units 3 which rest on a common running gear 10 are equipped with a twist blocking unit which prevents a free mutual torsional movement of the two frame part 8, 9 about the longitudinal axis 16 of the device. The twist blocking unit comprises two frame protrusions 18 which protrude from a respective frame flank 17 in the longitudinal direction 16 of the device against the frame 8 of the adjoining material-conveying silo unit 3 and which engage in respective diametrically opposed guide receivers 19. Rollers 20, which are cambered laterally, at the top and bottom of the frame protrusions 18, are mounted in the guide receivers 19 for guiding the frame protrusions 18 in the guide receivers 19.

The running gear 10 is formed with two axles in the embodiment and comprises a stop 22 on the upper side on a subframe 21 for the coupling lugs 23, 24 which protrude against each other from the frames 8, 9 of two mutually adjoining material-conveying silo units 3. In this respect, the coupling lug 23 surrounds the other coupling lug 24 in the manner of a fork and both coupling lugs 23, 24 act jointly on the stop 22. The two coupling lugs 23 and 24 are fixed with a coupling bolt 25 to the stop 22, which allows two degrees of freedom of rotation due to a ball clutch. The fork of the coupling lug 23 is connected at the bottom side to a pivot bearing 26 which is connected to the subframe 21 (the upper flange) of the running gear 10.

This configuration of the coupling allows horizontal and vertical twisting of the two frame part 8, 9 with respect to each other, through which the material-conveying silo units can adjust freely to the curves and the changes in inclination of the track.

1. A device for conveying material during track laying, comprising:
material-conveying silo units which can be moved on a track and receive material between side walls which define the silo chamber on a bottom conveyor belt for conveying the material along the bottom, wherein a material-conveying silo includes a plurality of material silo units which are coupled to one another and, in the region of end faces of the material silo units which face one another, include devices for transferring the material from one material-conveying silo unit to the next material-conveying silo unit, wherein the material-conveying silo unit is of articulated configuration, wherein the frames of two material-conveying silo units which adjoin one another are supported in an articulated manner on a common running gear, and the silo chamber is of continuous configuration, in particular with an at least approximately identical silo chamber cross-section over the length of the material-conveying silo.

2. A device according to claim 1, wherein longitudinal inclination and rotation compensation skirts are provided in the bottom region above the running gear and between the bottom conveyor belts of two mutually adjoining material-conveying silo units.

3. A device according to claim 2, wherein the longitudinal inclination and rotation compensation skirts are associated with an actuating drive, with which the longitudinal inclination and rotation compensation skirts can be lifted during unloading from a horizontal working position to an upright unloading position in order to supply residual material still resting on the longitudinal inclination and rotation compensation skirts after unloading to the discharging bottom conveyor belt.

4. A device according to claim 2, wherein the longitudinal inclination and rotation compensation skirts are formed as vibration conveyors, with which material resting on the inclination and rotation compensation skirts can be supplied to a discharging bottom conveyor belt.

5. A device according to claim 1, wherein the frames of two mutually adjoining material-conveying silo units resting on a common running gear are equipped with a twist blocking unit which prevents a free mutual torsional movement of the two frame parts around the longitudinal axis of the device.

6. A device according to claim 5, wherein the twist blocking unit includes at least one frame protrusion protruding from a frame flank in the longitudinal direction of the device against the frame of the adjoining material-conveying silo unit, which frame protrusion engages in a respective diametrically opposed guide receiver.

7. A device according to claim 1, wherein longitudinal compensation plates are associated with the side walls, which plates protrude at the face end against the adjoining material-conveying silo unit and are movably arranged on the side walls, wherein the mutually associated longitudinal compensation plates and optionally side walls of mutually adjoining material-conveying silo units overlap in the longitudinal direction of the device.

8. A device according to claim 7, wherein the mutually associated longitudinal compensation plates are mounted in an articulated manner at one end on a side wall in the longitudinal direction of the device and are displaceably guided at the other end along the side wall of the adjoining material-conveying silo unit.

9. A device according to claim 2, wherein the longitudinal inclination and rotation compensation skirts and/or the longitudinal compensation plates consist of especially wear-resistant material of low coefficient of friction, namely carbon fibre composite materials, hard-coated steel sheets or Hardox sheet metals.

10. A device according to claim 1, wherein the running gear includes single-axle, two-axle or three-axle bogeys or double bogeys, and includes, on the upper side, a stop for coupling lugs protruding against each other from the frames of two mutually adjoining material-conveying silo units, wherein one of the two coupling lugs surround the other one in the manner of a fork and both coupling lugs jointly act on the stop.

11. A device according to claim 1, wherein a diesel engine, a power generator and a control unit are provided for supplying and triggering the hydraulic systems of all material-conveying silo units.
